(19) United States
(12) Patent Application Publication
(10) Pub. No.: US 2010/0041284 A1
(43) Pub. Date: Feb. 18, 2010

(54) BASE FOR AN ELECTRIC LAMP

(76) Inventors: Martin Beck, Augsburg (DE); Robert Menzinger, Affing-Ortsteil Gebenhofen (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/448,710

(22) PCT Filed: Jan. 11, 2008
(86) PCT No.: PCT/EP2008/050264

§ 371 Date: Jul. 2, 2009

(30) Foreign Application Priority Data
Jan. 24, 2007 (DE) 10 2007 003 490.5

(51) Int. Cl. H01R 13/03; H01R 43/00; H01R 43/04; H01R 43/02

(52) U.S. Cl. 439/886; 29/885; 29/861; 29/860

(57) ABSTRACT

The invention relates to a holder for an electric lamp (1, 1′) with contact pins (7, 8; 7′, 8′) extending to the outside for making electrical contact with the lamp (1, 1′), wherein the contact pins (7, 8; 7′, 8′) at least in some regions are coated with a layer (11) that is electrically conductive and/or that protects the contact pins (7, 8; 7′, 8′) from corrosion. The invention also relates to a method for the production of a holder for an electric lamp.

### TECHNICAL FIELD

The invention relates to a base for an electric lamp with outwardly extending contact pins for making electrical contact with the lamp.

### PRIOR ART

Bases for electric lamps, in particular fluorescent lamps, which have two outwardly extending contact pins which can be plugged into a lampholder and are used for making contact between the electric lamp and the lampholder, are known. These contact pins are formed from brass or brass alloys. This material is relatively expensive.

### DESCRIPTION OF THE INVENTION

The object of the present invention is to provide an inexpensive base, wherein in particular the contact pins are intended to be capable of being realized inexpensively and with little complexity.

This object is achieved by a base which has the features of patent claim 1 and a method which has the features of patent claim 8.

A base according to the invention for an electric lamp, in particular a fluorescent lamp, comprises outwardly extending contact pins for making electrical contact with the lamp, in particular between said lamp and a lampholder. At least regions of the contact pins are coated with a layer which is electrically conductive and/or protects the contact pins from corrosion. As a result of this coating, which is designed so as to be electrically conductive and/or anticorrosive, preferably electrically conductive and anticorrosive, there is a wide variety of materials to choose from for the contact pin. In particular, it is no longer necessary to use the relatively expensive brass.

Furthermore, as a result of this coating, it is possible to achieve an at least identical functionality in comparison with bare, uncoated contact pins made from brass. In addition, the contact pins can be provided with a high level of resistance to corrosion under unfavorable climatic conditions, such as in salty air and in a maritime climate, for example, by means of the coating.

Furthermore, this design also makes a relatively inexpensive base possible.

Preferably, the layer is a enamel which has particles of an electrically conductive material. This makes it possible to apply the layer in a simple manner to the contact pins and to individually set the electrical conductivity, depending on the admixture of the particles. Furthermore, the specific composition of the enamel also makes it possible to individually set the corrosion resistance. The enamel can be formed, for example, on the basis of PTFE (polytetrafluoroethylene).

Preferably, the layer comprises particles of iron, aluminum, copper, silver, cerium, carbon, electrically conductive ceramic or a particle mixture comprising said elements. Provision can therefore be made for exclusively particles of iron or exclusively particles of aluminum or exclusively particles of copper or exclusively particles of silver or exclusively particles of cerium or exclusively particles of carbon or exclusively particles of ceramic to be admixed to the layer, in particular the enamel. However, provision can likewise also be made for particles of iron and/or particles of aluminum and/or particles of copper and/or particles of silver and/or particles of cerium and/or particles of carbon and/or particles of ceramic to be admixed. Provision can be made for the quantitative proportions of the different particles to be the same or else different in a particle mixture.

Preferably, the outer sides of the contact pins are covered over the entire area by the layer. In particular, provision may also be made for the contact pins, which are preferably hollow, to be covered over their entire surface, and therefore both on their outer side and on their inner side, by the layer.

Preferably, the contact pins are formed from an electrically conductive material, in particular from an aluminum-containing material, in particular completely from aluminum or an aluminum alloy. In interaction with the layer which in particular is in the form of a enamel with admixed electrically conductive particles, such a selection of material for the contact pin can take into account the stringent functional requirements placed on the base and in particular the contact pins during operation of the electric lamp. Furthermore, it is thus also possible to produce a design with little wear which is abrasion-resistant and can also be realized in a very inexpensive manner. The contact pins are in particular formed without the use of brass. In particular in the case of configurations comprising contact pins which at least proportionally comprise aluminum and are coated with the layer, particularly effective and inexpensive material variants can be made possible.

Provision can preferably be made for at least regions of a base housing, which accommodate the contact pins, to be coated with the layer. This also makes novel alternatives for the base coloring possible.

In a method according to the invention for producing a base for an electric lamp, contact pins for making electrical contact between the lamp and a lampholder are formed on the base. At least regions of the contact pins are coated with a layer which is electrically conductive and/or protects the contact pins from corrosion. In addition to a highly functional design, this also makes a relatively inexpensive design possible in comparison with brass contact pins.

Preferably, a wire, in particular a wire which at least proportionally comprises aluminum, is coated with the layer and, after the coating of the wire, is shaped to form the contact pin. As a result, a high degree of processability in the production flow of the base and the electric lamp can also be made possible. The already previously enameled wire is brought into the final shape of the contact pin by means of upsetting. In this case, the layer is in particular designed in such a way that, owing to the deformation of the coated wire, in particular in the case of a deep-drawing operation, the strength of this layer is sufficient and this layer is not damaged.

Preferably, a power supply line, which is plugged into a hollow contact pin, of an electrode of the lamp is connected to the contact pin by means of crimping or welding. The inner contact-making of the power supply line which is plugged into the contact pin can preferably be tested in an NaCl or SO₂ atmosphere. Testing this inner contact-making in such an atmosphere does not in any way impair the conductivity or result in increased transfer resistance between the contact pin and the power supply line. Preferably, the materials of the contact pin and the power supply line are selected in such a way that such an increased transfer resistance can be avoided. The selection of materials is carried out using the electrochemical series of metals in such a way that an uncritical pairing is selected in terms of transfer resistance. The power supply line can be formed from a copper-plated steel wire or from an aluminum-containing wire, for example.

Preferably, the composition of the layer is such that it withstands mechanical deformations such as may occur in the case of deep-drawing, upsetting, crimping or pinch-sealing or the like during the production of the base. Even in the case of severe reshapings, damage to or destruction of the layer can in this case be prevented. In particular, this can make it possible for production and further-processing to take place in time-optimized and cost-optimized fashion and for the layer to be applied even before the further mechanical reshaping of the contact pins.

In particular in the case of a configuration of the contact pin from aluminum or an aluminum-containing material, a deformability can be achieved which is similar to that of brass. As a result, it is possible to avoid resetting of production and manufacturing machines, or at most this is associated with only a relatively low degree of complexity. In addition to crimping, cold-welding of the power supply line to the contact pin can in particular also be provided. In particular, in this case a welded joint can be provided at the outer front end of a contact pin. However, it is also possible for soldering to be provided.

### BRIEF DESCRIPTION OF THE DRAWINGS

Exemplary embodiments of the invention will be explained in more detail below with reference to schematic drawings, in which:

FIG. 1 shows a schematic sectional illustration through a base of a-fluorescent lamp in accordance with a first exemplary embodiment;

FIG. 2 shows a schematic side view of a base according to the invention for an electric lamp in accordance with a second exemplary embodiment;

FIG. 3 shows a perspective illustration of a base housing of the base shown in FIG. 2; and

FIG. 4 shows a perspective illustration of a base in accordance with the embodiment in FIG. 2.

### PREFERRED EMBODIMENT OF THE INVENTION

Identical or functionally identical elements have been provided with the same reference symbols in the figures.

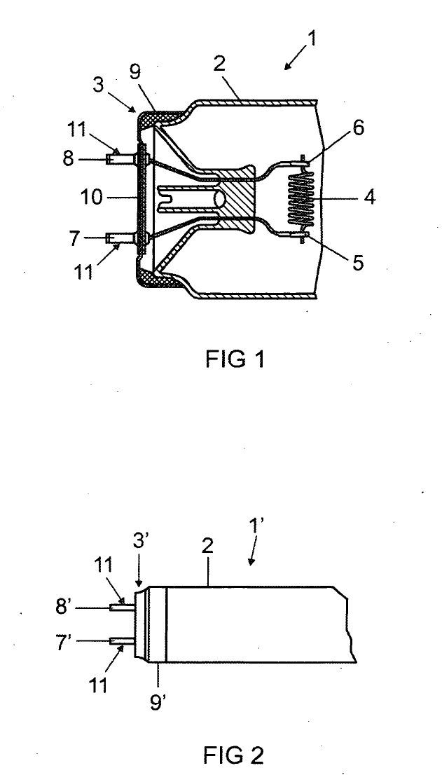

FIG. 1 shows a sectional illustration of a subregion of a linear fluorescent lamp 1, which has a tubular glass bulb 2. In each case one base is arranged at the two opposite ends of the linear glass bulb 2, with only the base 3 being shown in the partial illustration shown in FIG. 1. An electrode 4, which is connected to electrode holders or power supply lines 5 and 6, is arranged in the interior of the glass bulb 2. The power supply lines 5 and 6 open out into the base 3 and extend in particular into hollow contact pins 7 and 8. The contact pins 7 and 8 extend outwards from a base housing 9 and are intended to be inserted into a lampholder (not illustrated), as a result of which electrical contact can be made with the lamp 1.

The contact pins 7 and 8 are electrically insulated from one another by an insulating plate 10.

In the exemplary embodiment, the contact pins 7 and 8 are formed from aluminum and are in particular completely coated by a layer 11 both on the outer side and on the inner side. The layer 11 is in the form of a coating which is electrically conductive and protects the contact pins 7 and 8 from corrosion. In the exemplary embodiment, the layer 11 is an enamel, which has particles of an electrically conductive material. The admixture can comprise particles of iron and/or aluminum and/or copper and/or silver and/or cerium and/or carbon and/or ceramic. Preferably, however, copper or silver particles are admixed to the enamel since said particles ensure the best electrical conductivity. For cost reasons, copper particles are particularly preferred.

The power supply lines 5 and 6 can be crimped or welded to the contact pins 7 and 8.

FIG. 2 shows a further exemplary embodiment in a side view, in which a fluorescent lamp 1′ again comprises a linear glass bulb 2, with in each case one base arranged on the opposite sides thereof. FIG. 2 shows only the base 3′ in the partial detail shown. In contrast to the configuration in FIG. 1, the base housing 9′ has a different design therefrom. In this embodiment, contact pins 7′ and 8′ are likewise in turn completely coated with the layer 11. The power supply lines 5 and 6 (not illustrated) are fed in similarly to the configuration in FIG. 1.

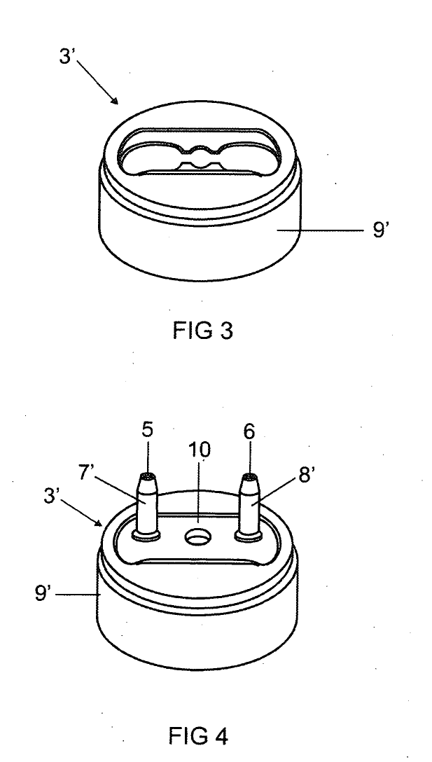

FIG. 3 shows a perspective illustration of the base housing 9′ of the embodiment in FIG. 2. In this case, the contact pins 7′ and 8′ illustrated in FIG. 4 extend through the openings formed on the upper side. Furthermore, FIG. 4 shows the insulating plate 10. Both the base housing 9′ and the contact pins 7′ and 8′ are formed from aluminum.

The contact pins 7′ and 8′ are manufactured from an aluminum wire, which is coated with the layer 11 prior to the actual deformation so as to form the contact pins 7′ and 8′ shown in FIG. 4. In this case, the final shape of the contact pins 7′ and 8′ is produced in particular by upsetting the coated aluminum wire. The deformation takes place by means of a deep-drawing operation, which the strength of the layer 11 withstands. The power supply lines 5 and 6 are connected to the contact pins 7′ and 8′ by means of crimping in the illustration shown in FIG. 4.

The contact pins 7 and 8 in FIG. 1 are produced correspondingly.

1. A base for an electric lamp (1, 1′) with outwardly extending contact pins (7, 8; 7′, 8′) for making electrical contact with the lamp (1, 1′),
characterized in that
at least regions of the contact pins (7, 8; 7′, 8′) are coated with a layer (11) which is electrically conductive and/or protects the contact pins (7, 8; 7′, 8′) from corrosion.

2. The base as claimed in claim 1,
characterized in that
the layer (11) is an enamel which has particles of an electrically conductive material.

3. The base as claimed in claim 2,
characterized in that
the layer (11) comprises particles of iron, aluminum, copper, silver, carbon, electrically conductive ceramic or a particle mixture comprising said elements.

4. The base as claimed in claim 1,
characterized in that
the outer sides of the contact pins (7, 8; 7′, 8′) are covered over the entire area by the layer (11).

5. The base as claimed in claim 1,
characterized in that
the contact pins (7, 8; 7′, 8′) are formed from electrically conductive material.

6. The base as claimed in claim 1,
characterized in that
the contact pins (7, 8; 7′, 8′) are hollow.

7. The base as claimed in claim 1,
characterized in that
at least regions of a base housing (9, 9′), which accommodate the contact pins (7, 8; 7′, 8′), are coated with the layer (11).

8. A method for producing a base (3, 3′) for an electric lamp (1, 1′), in which contact pins (7, 8; 7′, 8′) for making electrical contact with the lamp (1, 1′) are formed on the base (3, 3′),
characterized in that
at least regions of the contact pins (7, 8; 7′, 8′) are coated with a layer (11) which is electrically conductive and/or protects the contact pins (7, 8; 7′, 8′) from corrosion.

9. The method as claimed in claim 8,
characterized in that
a wire comprises aluminum, is coated with the layer (11) and, after the coating of the wire, is shaped to form the contact pin (7, 8; 7′, 8′).

10. The method as claimed in claim 8 or 9,
characterized in that
a power supply line (5, 6), which is plugged into a hollow contact pin (7, 8; 7′, 8′), of an electrode (4) of the lamp (1, 1′) is connected to the contact pin (7, 8; 7′, 8′) by means of crimping or welding.

11. The method as claimed in claim 8 or 9,
characterized in that
the composition of the layer (11) is such that it withstands mechanical deformations such as may occur in the case of deep-drawing, upsetting, crimping or pinch-sealing or the like during the production of the base.

12. The base as claimed in claim 1, characterized in that the contact pins (7, 8; 7′, 8′) are formed from aluminum or from an aluminum-containing material.

13. The method as claimed in claim 8,
characterized in that
a wire which at least proportionally comprises aluminum, is coated with the layer (11) and, after the coating of the wire, is shaped to form the contact pin (7, 8; 7′, 8′).
